(19) United States
(12) Patent Application Publication
(10) Pub. No.: US 2025/0036946 A1
(43) Pub. Date: Jan. 30, 2025

(54) DEVICE AND METHOD FOR TRAINING DEEP LEARNING MODEL THAT SUPPORTS MULTI-LEVEL MULTI-LENGTH LATENT VECTORS

(71) Applicant: KOREA UNIVERSITY RESEARCH AND BUSINESS FOUNDATION, Seoul (KR)

(72) Inventors: Taegun AN, Seoul (KR); Changhee JOO, Seoul (KR)

(21) Appl. No.: 18/777,030

(22) Filed: Jul. 18, 2024

(30) Foreign Application Priority Data
Jul. 28, 2023 (KR) 10-2023-0099076

(51) Int. Cl. G06N 3/08; G06N 3/0455

(52) U.S. Cl. CPC G06N 3/08; G06N 3/0455

(57) ABSTRACT

Disclosed is a device and method of training a deep learning model capable of using multi-level and multi-length latent vectors. The method of training the deep learning model is performed by a computing device including at least a processor and includes generating a basic model; and training the basic model, and the basic model includes a plurality of layer blocks each including at least one layer, and the layer blocks include first layer blocks configured to receive input data or output of a previous layer block to compress or encode data, or to output a latent vector corresponding to the input data and second layer blocks configured to receive the latent vector and the output of the previous layer block to restore or decode the data, or to derive inference results corresponding to the input data.

### CROSS-REFERENCE TO RELATED APPLICATION(S)

This application claims the benefit under 35 USC § 119 (a) of Korean Patent Application No. 10-2023-0099076 filed on Jul. 28, 2023 in the Korean Intellectual Property Office, the entire disclosure of which is incorporated herein by reference for all purposes.

### BACKGROUND

### 1. Field

At least one example embodiment relates to a deep learning model and a technique of training the deep learning model, and more particularly, to a design and a training technique of a deep learning model having a multi-length latent vector.

### 2. Description of Related Art

The internal operating principle of a multi-neural network model that constitutes machine learning technology called deep learning is not clearly known. However, according to recent experimental results, many related researchers agree that deep learning is most excellent among machine learning technologies. Since it is impossible to numerically interpret the internal operating principle of a neural network model that enables deep learning, many deep learning neural network models use a method of finding an optimal approximate solution by changing hyperparameters and a model structure several times based on prior knowledge and mathematical heuristics.

However, the related art considers the entire deep learning model as one model and proceeds with training with one training goal. Therefore, all levels included in the deep learning model need to be passed to acquire desired inference results. A change in and/or omission of an intermediate structure within the deep learning model causes serious degradation in performance. Accordingly, there is a difficulty in applying the related art to various distributed computing techniques and, although applied, issues, such as degradation in performance and increase in computation time arise.

Therefore, proposed is a design and/or a training technique of a deep learning model to improve the aforementioned issues.

### SUMMARY

A technical subject of at least one example embodiment is to provide a device and method of training a deep learning model capable of using multi-level and multi-length latent vectors.

According to an example embodiment, a method of training a deep learning model capable of using a multi-level and multi-length latent vector is performed by a computing device including at least a processor, and includes generating a basic model; and training the basic model, and the basic model includes a plurality of layer blocks each including at least one layer, and the layer blocks include first layer blocks configured to receive input data or output of a previous layer block to compress or encode data, or to output a latent vector corresponding to the input data and second layer blocks configured to receive the latent vector and the output of the previous layer block to restore or decode the data, or to derive inference results corresponding to the input data.

According to a device and method of training a deep learning model capable of using multi-level and multi-length latent vectors according to example embodiments, it is possible to design and train a deep learning model that generates latent vectors with various lengths without no or minimum degradation in performance.

Also, since an intermediate level of the deep learning model may be readily omitted based on characteristics of the deep learning model proposed herein, it is possible to derive more excellent inference effect through application to various distributed computing techniques.

The aforementioned features and effects of the disclosure will be apparent from the following detailed description related to the accompanying drawings and accordingly those skilled in the art to which the disclosure pertains may easily implement the technical spirit of the disclosure.

### BRIEF DESCRIPTION OF THE DRAWINGS

These and/or other aspects, features, and advantages of the disclosure will become apparent and more readily appreciated from the following description of example embodiments, taken in conjunction with the accompanying drawings of which:

FIG. 1 illustrates a structure of a deep learning model for describing a process of training the deep learning model according to the related art;

FIG. 2 illustrates a structure of a deep learning model according to an example embodiment;

FIG. 3 illustrates an example of describing a method of training the deep learning model of FIG. 2;

FIG. 4 illustrates a deep learning model of which training is completed;

FIG. 5 illustrates a usage example of a deep learning model according to an example embodiment;

FIGS. 6A to 6C illustrate examples of a structure of a deep learning model according to an example embodiment; and

FIG. 7 is a flowchart illustrating a method of training a deep learning model according to an example embodiment.

### DETAILED DESCRIPTION

The aforementioned features and effects of the disclosure will be apparent from the following detailed description related to the accompanying drawings and accordingly those skilled in the art to which the disclosure pertains may easily implement the technical spirit of the disclosure.

Various modifications and/or alterations may be made to the disclosure and the disclosure may include various example embodiments. Therefore, some example embodiments are illustrated as examples in the drawings and described in detailed description. However, they are merely intended for the purpose of describing the example embodiments described herein and may be implemented in various forms. Therefore, the example embodiments are not construed as limited to the disclosure and should be understood to include all changes, equivalents, and replacements within the idea and the technical scope of the disclosure.

Although terms of “first,” “second,” and the like are used to explain various components, the components are not limited to such terms. These terms are used only to distinguish one component from another component.

For example, a first component may be referred to as a second component, or similarly, the second component may be referred to as the first component within the scope of the present disclosure. As used herein, the term “and/or” includes any and all combinations of one or more of the associated listed items.

As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Hereinafter, example embodiments will be described with reference to the accompanying drawings. However, the scope of the patent application is not limited to or restricted by such example embodiments. Like reference numerals used herein refer to like elements throughout.

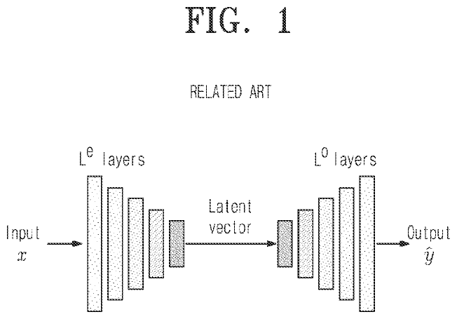

FIG. 1 illustrates a structure of a deep learning model for describing a process of training the deep learning model according to the related art.

Referring to FIG. 1 illustrating a structure of an autoencoder (AE) as an example, the related art considers the deep learning model as one model and trains the same at once with the same training goal. Therefore, when an intermediate structure of the deep learning model is changed or omitted, it causes rapid degradation in performance.

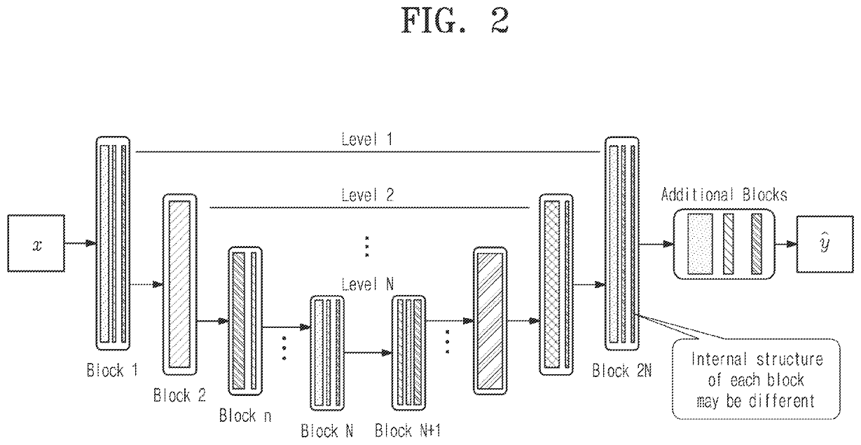

FIG. 2 illustrates a structure of a deep learning model according to an example embodiment.

Referring to FIG. 2, the deep learning model refers to an arbitrary artificial neural network (AAN) and includes a plurality of layer blocks each including at least one layer. Depending on example embodiments, the deep learning model may include at least one additional block that follows the plurality of layer blocks. Therefore, output of the deep learning model may be output of a last layer block among the plurality of layer blocks or output of the at least one additional block.

In more detail, the plurality of layer blocks may include 2N layer blocks. Here, N denotes an arbitrary natural number. Each of the layer blocks may have the same or different internal structure. That is, each of the layer blocks includes at least one layer and type and/or number of the at least one layer included in each of the layer blocks may be the same or different. Also, a plurality of layers may include N layer blocks (also, referable to as first layer blocks) for generating a latent vector corresponding to input (input data) and N layer blocks (also, referrable to as second layer blocks) for generating output from the latent vector. Depending on example embodiments, the deep learning model refers to a neural network model in an encoder-decoder structure and may be understood to include N encoding blocks and N decoding blocks.

Each of the plurality of layer blocks may have a level. Here, N level depths may be present. A level of each of the first layer blocks may be sequentially assigned. That is, a level of a layer block that receives input (input data) may be 1 and a layer block that generates a latent vector may be N. Also, a level of each of the second layer blocks may be assigned in reverse order. That is, a level of a layer block that receives a latent vector may be N and a level of a last layer block may be 1.

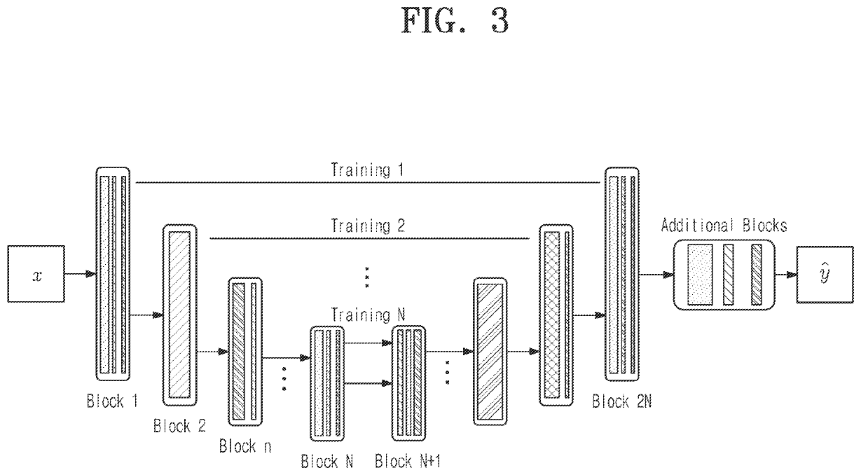

FIG. 3 illustrates an example of describing a method of training the deep learning model of FIG. 2.

Referring to FIG. 3, training of the deep learning model may proceed in level order. That is, N training processes may be performed to train layer blocks corresponding to each level. For example, in a first training process (Training 1), only layer blocks of level 1 are included in a corresponding training process. That is, it may be understood that a first layer block (Block 1) generates a latent vector for input data and a 2N-th layer block (Block 2N) generates output for the latent vector. Here, output of the 2N-th layer block may become final results through additional layer blocks.

When the first training process is completed, a second training process (Training 2) is performed. In the second training process, a parameter (e.g., weight) for the layer blocks participating in the first training process is frozen and only layer blocks of level 2 participate in the corresponding training process. That is, a second layer block (Block 2) receives output of the first layer block (Block 1) to generate a final latent vector, and the 2N-th layer block (Block 2N) receives output of a (2N−1)-th layer block (Block 2N−1) to derive output corresponding thereto.

For example, in a k-th (k=natural number greater than equal to 1 and less than or equal to N) training process, only layer blocks of level k participate in the corresponding training process while freezing a parameter for layer blocks that participate in training processes from the first training process to a (k−1)-th training process. Training may proceed to minimize a predetermined loss function.

Alternatively, without fixing the parameters of the previous levels, it is also possible to train the layer blocks of level k after finely tuning various hyperparameters (including optimizer, learning rate, batch size, and model size, etc.) involved from the first training process to the (k−1)-th training process.

Once training of layer blocks up to level N is completed, training of an additional layer block may be additionally performed.

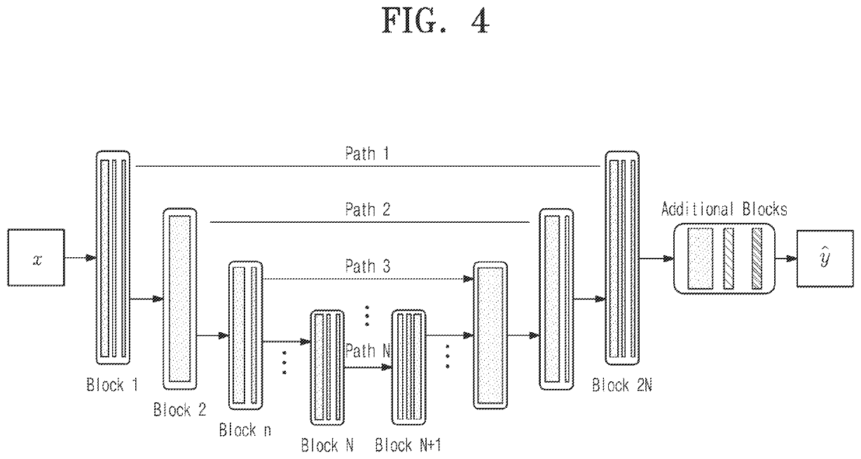

FIG. 4 illustrates a deep learning model of which training is completed.

Referring to FIG. 4, the deep learning model of which training is completed has a plurality of operation paths (also, referrable to as paths, inference paths). For example, in the deep learning model of which training is completed, n operation paths are present between input and output. Here, n denotes an arbitrary natural number and may have the same value as N. Therefore, inference (or operation) may be performed by selecting an appropriate operation path according to computational resources and/or other situations.

The present invention relates to a method of training a deep learning model that performs an arbitrary inference operation. Therefore, training data used for training may vary depending on an inference goal of the deep learning model. Also, each training process may use the same loss function or may use a different loss function.

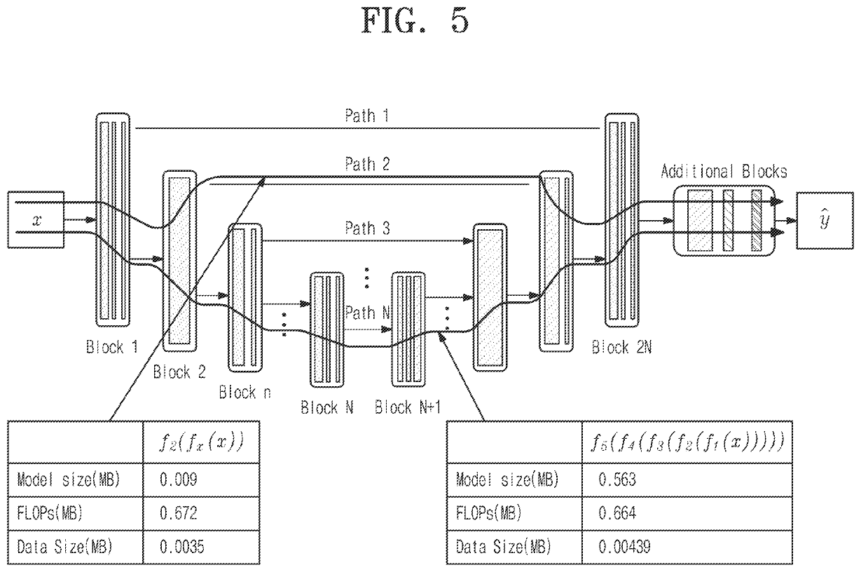

FIG. 5 illustrates a usage example of a deep learning model according to an example embodiment.

In a system or a distributed system in which a computational amount dynamically changes according to a change in operation load and data amount (or traffic), the respective example paths A and B may be selected in the following cases to take the advantage.

Path A may be selected and used as an operation path when computational resources are sufficient and traffic may not be accommodated due to a lot of traffic. Path B may be selected and used as an operation path when computational resources are insufficient and a large amount of traffic may be accommodated.

In this regard, Table 1 below shows an example of a 5-level performance table of the deep learning model.

TABLE 1

| | x | f₁(x) | f₂(fₓ(x)) | f₃(f₂(f₁(x))) | f₄(f₃(f₂(f₁(x)))) | f₅(f₄(f₃(f₂(f₁(x))))) |
|---|---|---|---|---|---|---|
| Model size (MB) | — | 0.002 | 0.009 | 0.035 | 0.141 | 0.563 |
| FLOPs (MB) | — | 0.516 | 0.672 | 0.688 | 0.665 | 0.664 |
| Data Size (MB) | 0.105 | 0.070 | 0.0035 | 0.0175 | 0.00878 | 0.00439 |

When an operation of each layer (, which may indicate a layer block) is fᵢ (i=1, 2, . . . , 5), Table 1 shows a model size, a computational amount, and a size of a deep vector for each layer. Referring to Table 1, it can be seen that a data size rapidly decreases (i.e., very small compared to the original) according to an increase in layer depth. Here, a value may vary depending on the deep learning model.

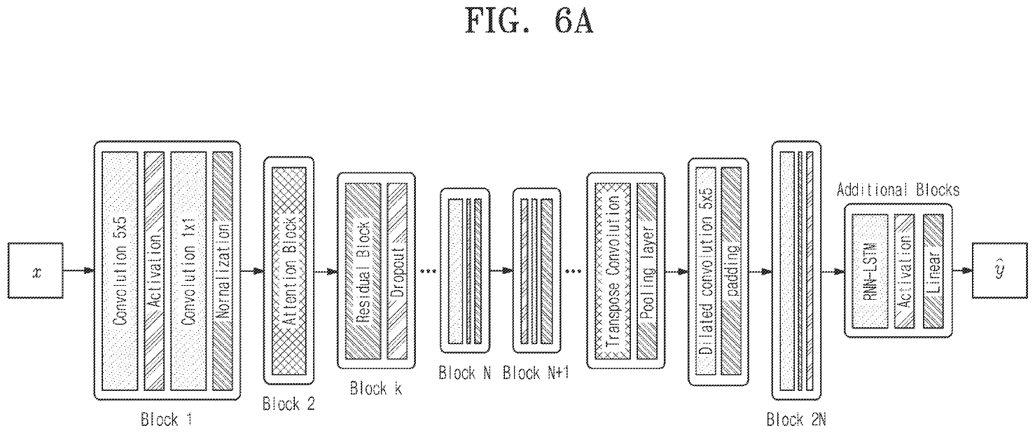

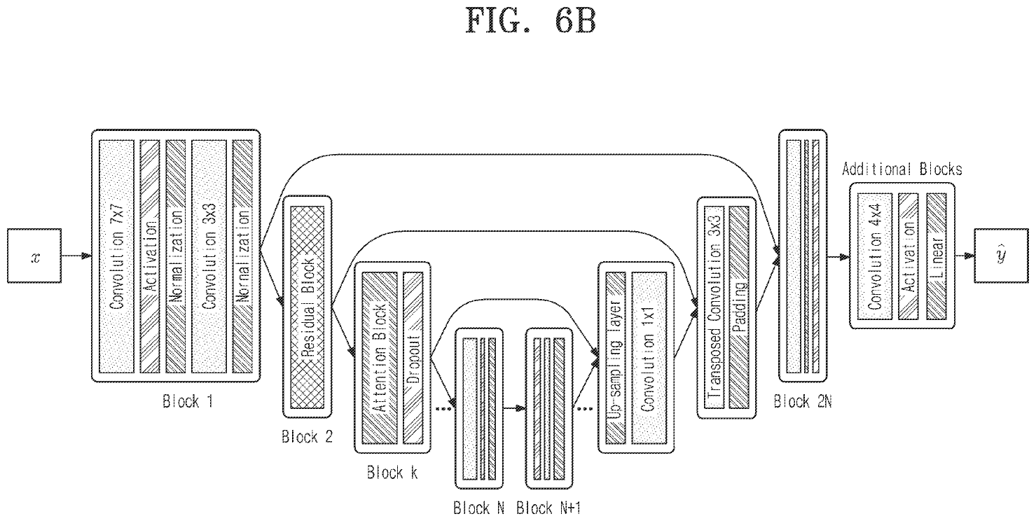

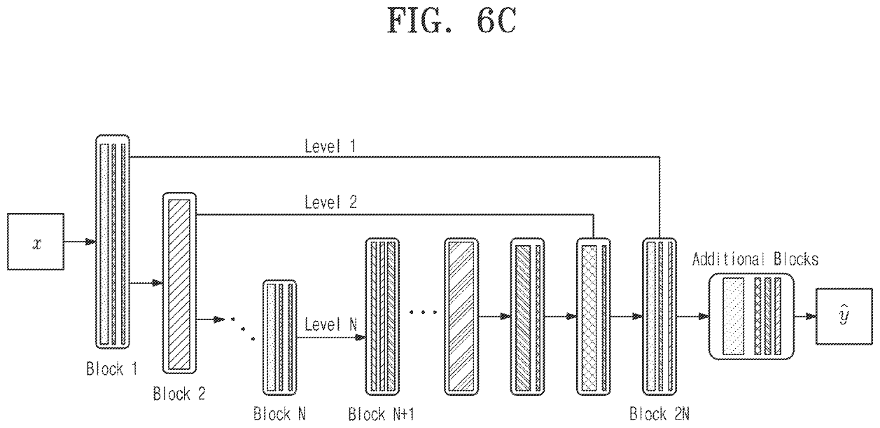

FIGS. 6A to 6C illustrate examples of a structure of a deep learning model according to an example embodiment.

The example of FIG. 6A refers to an autoencoder model and blocks (layer blocks) of each level may have an arbitrary structure. That is, blocks within each layer block represent a layer that performs an arbitrary operation. The example of FIG. 6B refers to a U-Net model and the respective layer blocks may have an arbitrary structure. The example of FIG. 6C refers to a case of having an arbitrary model structure and may have a block structure different from those shown in FIGS. 6A and 6B and, at the same time, may have an arbitrary (asymmetric) structure. Depending on example embodiments, a structure, such as VGG that is a popular model, may be included.

Training data and a training algorithm are described.

Training data may be an arbitrary N-dimensional vector. Here, 1D may represent a simple vector input, 2D may represent image input, and 3D may represent video input. An example of the training algorithm is as follows.

### [Training Algorithm]

Algorithm 1 Training Method

| 1: | Input: Dataset D | [symbol] D can be any dataset: |
|---|---|---|
| 2: | Initialize: Model with N levels − blocks f₁,f₂,...,f_{2N-1},f_{2N} with parameters θ_{f}_{₁},θ_{f}_{₂},...,θ_{f}_{_{2N−1}},θ_{f}_{_{2N}} | |
| 3: | for l = 1,2,...,N do | |
| 4: | while not converged do | |
| 5: | get data batch d ~ D | |
| 6: | go through v [symbol] = f [symbol] (f [symbol] ₋₁(f...(f [symbol] (d)))) | [symbol] v [symbol] is the latent vector |

| | |
|---|---|
| 7: | go through d = f_{2N}(f_{2N-1}(f...(f_{2N-} [symbol] ₊₁(d)))) |
| 8: | compute loss [symbol] (d,d) |
| 9: | optimize θ_{f}_{₁},θ_{f}_{_{2N−}} [symbol] _{₊₁} |
| 10: | end while |
| 11: | fix θ_{f}_{₁},θ_{f}_{_{2N−1}} |
| 12: | end for |

[symbol]

indicates data missing or illegible when filed

The deep learning model having original dataset D₁ and N levels is assumed. A dataset may have a form, such as time-series, an image, and a video. Also, layer blocks of the model are represented as f₁, . . . , f_{2N}, and parameters are represented as θ_{f1}, . . . , θ_{f}_{_{2N}}. Levels from level 1 to level N may be trained through [Algorithm 1] above. Here, each level may use any loss function L.

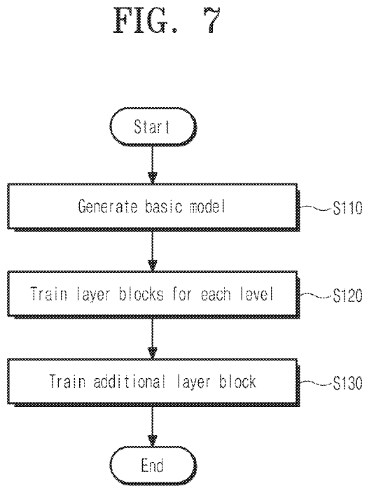

FIG. 7 is a flowchart illustrating a method of training a deep learning model according to an example embodiment.

The method of training the deep learning model as shown in FIG. 7 may be performed by a computing device including at least a processor and/or memory. Therefore, at least a portion of operations included in the method of training the deep learning model may be understood as an operation of the processor included in the computing device. The computing device includes, for example, a personal computer (PC), a server, a laptop computer, a tablet PC, and the like. Herein after, in describing the method of training the deep learning model, further description related to repeated contents is omitted.

In operation S110, a basic model is generated. The basic model refers to a deep learning model for training and may represent an arbitrary neural network model. The basic model may include a plurality of layer blocks each including at least one layer. For example, the basic model may include 2N layer blocks. Here, N denotes an arbitrary natural number. Also, the layer blocks may include N first layer blocks configured to receive input data or output of a previous layer block to compress or encode data, and/or to generate (or output) a latent vector and N second layer blocks configured to receive the latent vector or input of the previous layer block to restore or decode the data, and/or to derive (or output) inference results corresponding to the input data.

Also, the layer blocks may have predetermined levels. The first layer blocks may be sequentially assigned levels in ascending order thereof and the second layer blocks may be assigned levels in descending order thereof. Through this, layer block pairs each with the same level from a first level to an 1N-th level may be generated.

Depending on example embodiments, the basic model may further at least one additional layer block at the rear of the second layer blocks.

In operation S120, training of the layer blocks may be performed for each level (e.g., in ascending order of levels). Training of layer blocks corresponding to an N-th level may be performed, starting from training of layer blocks corresponding to a first level. Here, training of layer blocks of an arbitrary level may be performed while freezing a parameter for layer blocks of a previous level.

In operation S130, training of an additional layer block is performed. Training of the additional layer block may be performed while freezing a parameter for layer blocks. Through the aforementioned process, training of the deep learning model having a plurality of operation paths (or inference paths) may be completed.

The aforementioned method according to example embodiments may be implemented in a form of a program executable by a computer apparatus. Here, the program may include, alone or in combination, a program instruction, a data file, and a data structure. The program may be specially designed to implement the aforementioned method or may be implemented using various types of functions or definitions known to those skilled in the computer software art and thereby available. Also, here, the computer apparatus may be implemented by including a processor or a memory that enables a function of the program and, if necessary, may further include a communication apparatus.

The program for implementing the aforementioned method may be recorded in computer-readable record media. The media may include, for example, a semiconductor storage device such as an SSD, ROM, RAM, and a flash memory, magnetic disk storage media such as a hard disk and a floppy disk, optical record media such as disc storage media, a CD, and a DVD, magneto optical record media such as a floptical disk, and at least one type of physical device capable of storing a specific program executed according to a call of a computer such as a magnetic tape.

Although some example embodiments of an apparatus and method are described, the apparatus and method are not limited to the aforementioned example embodiments. Various apparatuses or methods implementable in such a manner that one of ordinary skill in the art makes modifications and alterations based on the aforementioned example embodiments may be an example of the aforementioned apparatus and method. For example, although the aforementioned techniques are performed in order different from that of the described methods and/or components such as the described system, architecture, device, or circuit may be connected or combined to be different form the above-described methods, or may be replaced or supplemented by other components or their equivalents, it still may be an example embodiment of the apparatus and method.

The device described above can be implemented as hardware elements, software elements, and/or a combination of hardware elements and software elements. For example, the device and elements described with reference to the embodiments above can be implemented by using one or more general-purpose computer or designated computer, examples of which include a processor, a controller, an ALU (arithmetic logic unit), a digital signal processor, a microcomputer, an FPGA (field programmable gate array), a PLU (programmable logic unit), a microprocessor, and any other device capable of executing and responding to instructions. A processing device can be used to execute an operating system (OS) and one or more software applications that operate on the said operating system. Also, the processing device can access, store, manipulate, process, and generate data in response to the execution of software. Although there are instances in which the description refers to a single processing device for the sake of easier understanding, it should be obvious to the person having ordinary skill in the relevant field of art that the processing device can include a multiple number of processing elements and/or multiple types of processing elements. In certain examples, a processing device can include a multiple number of processors or a single processor and a controller. Other processing configurations are also possible, such as parallel processors and the like.

The software can include a computer program, code, instructions, or a combination of one or more of the above and can configure a processing device or instruct a processing device in an independent or collective manner. The software and/or data can be tangibly embodied permanently or temporarily as a certain type of machine, component, physical equipment, virtual equipment, computer storage medium or device, or a transmitted signal wave, to be interpreted by a processing device or to provide instructions or data to a processing device. The software can be distributed over a computer system that is connected via a network, to be stored or executed in a distributed manner. The software and data can be stored in one or more computer-readable recorded medium.

A method according to an embodiment of the invention can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the present invention or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc., specially designed to store and execute program instructions. Examples of the program instructions may include not only machine language codes produced by a compiler but also high-level language codes that can be executed by a computer through the use of an interpreter, etc. The hardware mentioned above can be made to operate as one or more software modules that perform the actions of the embodiments of the invention and vice versa.

While the present invention is described above referencing a limited number of embodiments and drawings, those having ordinary skill in the relevant field of art would understand that various modifications and alterations can be derived from the descriptions set forth above. For example, similarly adequate results can be achieved even if the techniques described above are performed in an order different from that disclosed, and/or if the elements of the system, structure, device, circuit, etc., are coupled or combined in a form different from that disclosed or are replaced or substituted by other elements or equivalents. Therefore, various other implementations, various other embodiments, and equivalents of the invention disclosed in the claims are encompassed by the scope of claims set forth below.

What is claimed is:

1. A method of training a deep learning model, performed by a computing device comprising at least a processor, the method comprising:
generating a basic model; and
training the basic model,
wherein the basic model includes a plurality of layer blocks each including at least one layer, and
the layer blocks include first layer blocks configured to receive input data or output of a previous layer block to compress or encode data, or to output a latent vector corresponding to the input data and second layer blocks configured to receive the latent vector and the output of the previous layer block to restore or decode the data, or to derive inference results corresponding to the input data.

2. The method of claim 1, wherein:
the first layer blocks are sequentially assigned levels from a first level to an N-th level, N denoting an arbitrary natural number,
the second layer blocks are assigned levels in reverse order from the first level to the N-th level,
the training of the basic model comprises training the layer blocks in ascending order of levels.

3. The method of claim 2, wherein the training of the basic model comprises performing training of layer blocks of a current level while freezing a parameter for layer blocks of a previous level.

4. The method of claim 1, wherein the basic model further includes at least one additional layer block that follows the plurality of layer blocks.

5. The method of claim 4, further comprising:
performing training of the at least one additional layer block.

6. The method of claim 5, wherein the performing training of the at least one additional layer block is performed while freezing a parameter of each of the layer blocks.

7. The method of claim 1, wherein the deep learning model of which training is completed has a plurality of inference paths.
